(19) United States
(12) Patent Application Publication
(10) Pub. No.: US 2007/0263870 A1
(43) Pub. Date: Nov. 15, 2007

(54) SECURE COMMUNICATION CHANNEL ACTIVATION SYSTEM

(76) Inventor: Andrew J. Czuchry, Auburn, GA (US)

Correspondence Address: W. EDWARD RAMAGE, COMMERCE CENTER SUITE 1000, 211 COMMERCE ST, NASHVILLE, TN, 37201, US

(21) Appl. No.: 11/747,744

(22) Filed: May 11, 2007

Related U.S. Application Data
(60) Provisional application No. 60/747,037, filed on May 11, 2006.

(51) Int. Cl. H04K 1/00

(52) U.S. Cl. 380/255

(57) ABSTRACT

Aan activation system for secure communication technology. In one embodiment, modular processing elements for account creation, account activation, software packaging, software activation, and software processing function independently. An integration module synthesizes activation and authentication for the account and software. Account activation and software activation are de-coupled, while providing an integration module for activation authentication, resulting in an activation system for maintaining the security of digital content handling within digital communication channels.

This application claims benefit of, and priority to, U.S. Provisional Patent Application No. 60/747,037, filed May 11, 2006, entitled “SECURE COMMUNICATION CHANNEL ACTIVATION SYSTEM.” The specification, drawings, and complete disclosure of U.S. Provisional Patent Application No. 60/747,037 are incorporated herein by specific reference.

### TECHNICAL FIELD

The present invention relates to information management and telecommunications systems. More particularly, the present invention relates to an activation system for secure communication technology.

### BACKGROUND OF THE INVENTION

Secure communication requires several vital components to maintain an authenticated security model. Two elements among these components are key: secure system activation, and secure system processing. Many software and hardware systems address the secure processing component, but there is a general lack in the field of an integrated secure system activation mechanism decoupled from the system processing, and that automatically re-integrates the activation and processing components.

Accordingly, there is a need in the art for a decoupled secure activation system for accounts and processes with the objective of maintaining the security of digital content handling within digital communication channels, and that can subsequently be integrated with activation and processing components. It is to such that the present invention is directed.

### SUMMARY OF THE INVENTION

This invention is directed to an information-based system for secure exchange of digital content. In an exemplary embodiment, the system integrates account creation, account activation, secure process model packaging, process model activation, and system processing elements.

In another exemplary embodiment, the system uses modular processing for account creation, account activation, software packaging, software activation, and software processing system elements independently, and an integration module to synthesize activation authentication.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a schematic illustration of a decoupled activation system for accounts and software in accordance with an exemplary embodiment of the present invention.

### DETAILED DESCRIPTION OF EXEMPLARY EMBODIMENTS

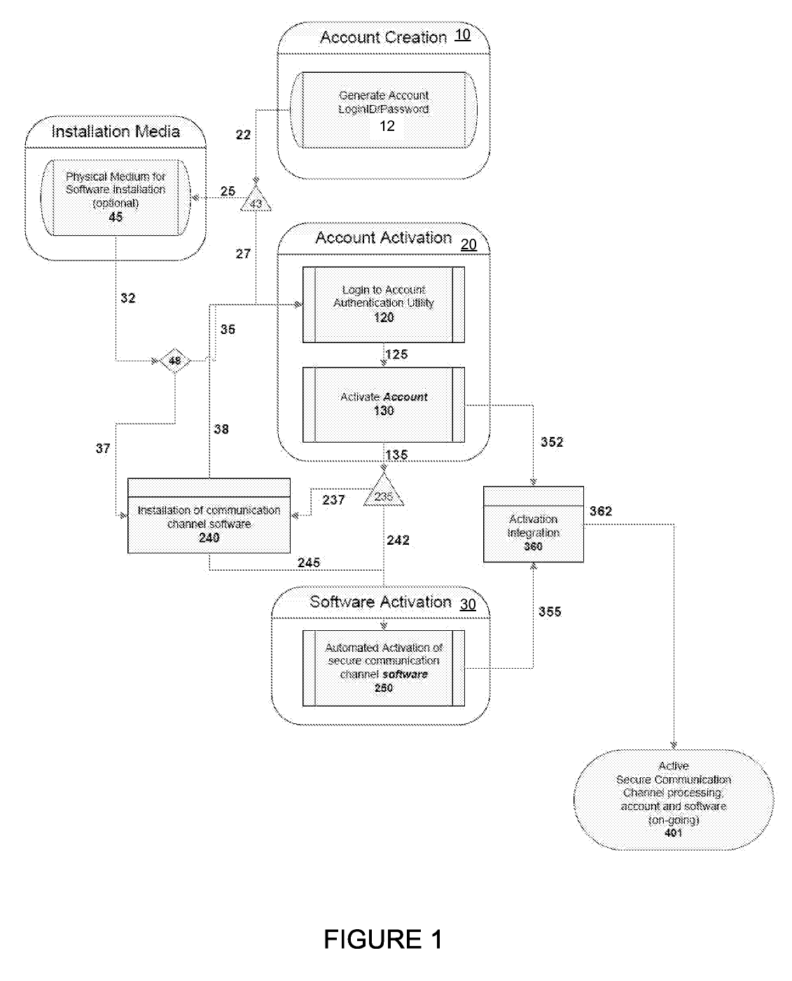

As shown in FIG. 1, one embodiment of a decoupled activation system for accounts and software comprises an initial account creation module 10 and an account activitation module or utility 20.

The initial account creation module 10 generates and configures an account (e.g., account name, login identification, password, etc.) 12, but does not activate the account. The account is an “account shell” that does not activate until the activation process (described below) is completed.

Account creation may be accomplished with or without physical installation media 45. Physical installation media 45 can be integrated with account creation by following logic path 22 through decision point 43 selecting logic path 25. Installation of software may occur from the physical installation media 45 prior to activation by following logic path 32 through decision point 48 to logic path 37 and the execution of the software installation process 240.

Alternatively, account activation can occur prior to installation of software from physical installation media 45 by following logic path 32 through decision point 48 to logic path 38. If, as described above logic path 37 is followed to proceed with software installation 240, then after installation of communication channel software 240, logic path 38 is used to return to the account activation module or utility 20.

Alternatively, if physical installation media 45 was not created or used, then the account activation process is initiated through logic path 22 via decision point 43 to logic path 27.

The account activation module 20 comprises an account authentication module or utility 120 and the activate account module 130. The account login credentials (e.g., login id, password 12) from the account creation module 10 are input by the user at the interface of the account authentication utility 120 in order to initiate the account activation process. The login credentials are checked and verified. Authenticated logins follow logic path 125 to the activate account module 130, which causes the account shell to be activated.

Software activation 30 may proceed from account activation 130 via logic path 135 to decision point 235. If communication channel software has not already been installed 240, then decision point 235 triggers logic path 237 to result in channel software installation 240. Subsequent to software installation 240, software activation 30 is initiated via logic path 245. If the communication channel software was installed previously (e.g., via logic path 37), then decision point 235 leads directly to software activation 30 via logic path 242. T

Software activation 30 comprises a software activation module or utility 250. The account login credentials (e.g., login id/password 12) from the account creation module 10 are input by the user at the interface of the software activation module 250 to activate the software.

Completion of account activation 130 and software activation 250 triggers activation integration 360 through independent logic paths 352 and 355. Subsequently, logic path 362 leads to opening the digital communication channel and secure communication processing 401.

Each logic path may be automated, leverage computer-assisted logic flow, or executed manually by any specific user to activate their corresponding user account.

The system provides account creation 10 independent of activation authentication 120, preparation of installation media 45 independent of account activation 20, account activation 20 independent of software activation 30, software activation 30 independent of account activation 20, and integrated activation and authentication 360 based on the independent integration of account and software.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

I claim:

1. A secure communication channel activation system, comprising:
an account creation module adapted to create an account; and
an account activation module adapted to activate the account, wherein account activation is independent from account creation.

2. The system of claim 1, further comprising:
a software installation module, adapted to install communication channel software; and
a software activation module, adapted to activate the communication channel software.

3. The system of claim 2, further comprising physical media for communication channel software installation.

4. The system of claim 2, further comprising an activation integration module.

5. The system of claim 1, wherein account login information is generated by the account creation module.

6. The system of claim 2, wherein software activation is independent from account creation or account activation.

7. The system of claim 4, wherein integrated activation and authentication is based on the independent integration of account activation and software activation.
